(19) United States
(12) Patent Application Publication
(10) Pub. No.: US 2022/0042426 A1
(43) Pub. Date: Feb. 10, 2022

(54) VALVE TIMING ADJUSTMENT DEVICE

(71) Applicant: DENSO CORPORATION, Kariya-city (JP)

(72) Inventor: Masao KURISU, Kariya-city (JP)

(21) Appl. No.: 17/393,722

(22) Filed: Aug. 4, 2021

(30) Foreign Application Priority Data
Aug. 7, 2020 (JP) 2020-135345

(51) Int. Cl. F01L 1/348; F01L 1/047

(52) U.S. Cl. CPC F01L 1/348; F01L 2250/02; F01L 2001/0476; F01L 1/047

(57) ABSTRACT

A valve timing adjustment device is configured to adjust an opening/closing timing of a valve by rotation of a cam shaft driven by a motor through a speed reduction mechanism. The speed reduction mechanism includes a rolling bearing and a thrust receiver. The rolling bearing includes a raceway groove to guide a rolling element at a surface of an inner ring and a surface of an outer ring. The raceway groove includes a deep groove provided at one side with respect to a center of the rolling element, and a shallow groove provided at the other side with respect to the center of the rolling element. The thrust receiver includes a first draining portion to discharge lubricating oil to outside of the rolling bearing from the shallow groove of the outer ring.

### CROSS REFERENCE TO RELATED APPLICATION

This application is based on Japanese Patent Application No. 2020-135345 filed on Aug. 7, 2020, the disclosure of which is incorporated herein by reference in its entirety.

### TECHNICAL FIELD

The present disclosure relates to a valve timing adjustment device for an engine.

### BACKGROUND

Conventionally, a valve timing adjustment device adjusts an opening/closing timing of a valve in an engine for a vehicle by rotation of a cam shaft driven by a motor through a speed reduction mechanism. The valve timing adjustment device includes multiple rolling bearings arranged in an axial direction of the speed reduction mechanism to secure reliability with respect to a moment load.

### SUMMARY

According to an aspect of the present disclosure, a valve timing adjustment device is configured to adjust an opening/closing timing of a valve provided at an engine by rotation of a cam shaft driven by a motor through a speed reduction mechanism. The speed reduction mechanism includes: at least one rolling bearing arranged between the motor and the cam shaft; an oiling passage through which lubricating oil is supplied to the rolling bearing; and at least one thrust receiver configured to lock the rolling bearing at a predetermined position in an axial direction. The rolling bearing includes a raceway groove to guide a rolling element at a surface of an inner ring and a surface of an outer ring that are opposed to each other. The raceway groove includes: a deep groove provided at one side of a center of the rolling element in the axial direction, and a shallow groove shallower than the deep groove and provided at the other side of the center of the rolling element in the axial direction. The thrust receiver includes a first draining portion to discharge the lubricating oil to an outside of the rolling bearing from the shallow groove of the outer ring.

### BRIEF DESCRIPTION OF DRAWINGS

FIG. 1 is a schematic view illustrating an engine which includes a valve timing adjustment device according to a first embodiment.

FIG. 2 is a cross-sectional view illustrating the valve timing adjustment device according to the first embodiment.

FIG. 3 is an enlarged view of an area Ill in FIG. 2 illustrating a speed reduction mechanism of the valve timing adjustment device.

FIG. 4 is a cross-sectional view illustrating a rolling bearing when an inner ring is tilted by a moment load.

FIG. 5 is a cross-sectional view illustrating the rolling bearing when an outer ring is tilted by a moment load.

FIG. 6 is a cross-sectional view showing a valve timing adjustment device according to a second embodiment.

### DETAILED DESCRIPTION

To begin with, examples of relevant techniques will be described.

Conventionally, a valve timing adjustment device adjusts an opening closing timing of a valve in an engine for a vehicle by rotation of a cam shaft driven by a motor through a speed reduction mechanism, A valve timing adjustment device includes multiple rolling bearings arranged in an axial direction of a speed reduction mechanism to secure reliability with respect to a moment load. In the valve timing adjustment device, lubricating oil is supplied from an innermost portion of the speed reduction mechanism, so as to flow in order from a small-diameter-side bearing to a large-diameter-side bearing. The lubricating oil lubricates four bearings, and is discharged from an outermost portion of the speed reduction mechanism to outside.

In another valve timing adjustment device, two rolling bearings are lined in an axial direction to minimize a speed reduction mechanism. That is, it proposes technique to minimize a speed reduction mechanism by reducing the number of rolling bearings while rigidity against a moment load and an axial load is secured. Further, a raceway groove of an inner ring and an outer ring to guide a rolling element is formed relatively deeply. Therefore, when a contact point between the raceway groove and the rolling element is displaced by a moment bad in the axial direction, the rolling element is guided by the deep raceway groove to restrict wear and deformation of the raceway groove due to stress concentration.

In the valve timing adjustment device, when the engine is stopped, the lubricating oil is discharged from the outermost portion of the speed reduction mechanism, that is, discharged from the lowest portion by gravity. However, a part of the lubricating oil is not discharged from the raceway groove and is retained. Because of this, when a temperature of the engine is lowered, the temperature of the lubricating oil is lowered. Then, the viscosity of the lubricating oil is increased before or immediately after the engine is started next time. If the speed reduction mechanism is driven in this state, a rolling element of the rolling bearing rolls against the lubricating oil having high viscosity. At this time, resistance of the lubricating oil may adversely affect a response speed of the speed reduction mechanism.

In a typical speed reduction mechanism used in the valve timing adjustment device, a rotational speed of an input member connected to a motor is usually set at several tens to hundreds times higher than that of an output member, in order to increase output supplied to a cam shaft. Therefore, the rolling bearing, which rotates at high speed at the input side, is more affected by viscous resistance of the lubricating oil. In addition, as the multiple rolling bearings are arranged so as to be offset in the radial direction in consideration of the moment load, the speed reduction mechanism is required to be larger. In addition, the resistance of the lubricating oil at the low temperature becomes larger according to the number of the rolling bearings.

In the valve timing adjustment device, the speed reduction mechanism is miniaturized by reducing the number of the rolling bearings, and resistance to the moment load can be enhanced. However, issue according to the resistance of the lubricating oil at the low temperature remains. As the raceway groove is formed relatively deeply, an amount of the lubricating oil retained at the raceway groove is increased.

The present disclosure provides a valve timing adjustment device that includes a speed reduction mechanism configured to reduce an amount of lubricating oil retained at a rolling bearing when an engine is stopped.

According to an aspect of the present disclosure, a valve timing adjustment device is configured to adjust an opening/closing timing of a valve provided at an engine by rotation of a cam shaft driven by a motor through a speed reduction mechanism. The speed reduction mechanism includes: at least one rolling bearing arranged between the motor and the cam shaft; an oiling passage through which lubricating oil is supplied to the rolling bearing; and at least one thrust receiver configured to lock the rolling bearing at a predetermined position in an axial direction. The rolling bearing includes a raceway groove to guide a rolling element at a surface of an inner ring and a surface of an outer ring that are opposed to each other. The raceway groove includes: a deep groove provided at one side of a center of the rolling element in the axial direction, and a shallow groove shallower than the deep groove and provided at the other side of the center of the rolling element in the axial direction. The thrust receiver includes a first draining portion to discharge the lubricating oil to an outside of the roping bearing from the shallow groove of the outer ring.

In the valve timing adjustment device, the raceway groove of the rolling bearing includes the deep groove and the shallow groove. Because of this, when the engine is stopped, the lubricating oil flows down to the raceway groove of the outer ring by gravity. After that, the lubricating oil flows out of the rolling bearing through the shallow groove and is discharged through the first draining portion of the thrust receiver. As a result, an amount of the lubricating oil retained at the raceway groove can be reduced, and resistance of the lubricating oil can be reduced when or immediately after starting the engine. Therefore, a response speed of the speed reduction mechanism can be higher.

### First Embodiment

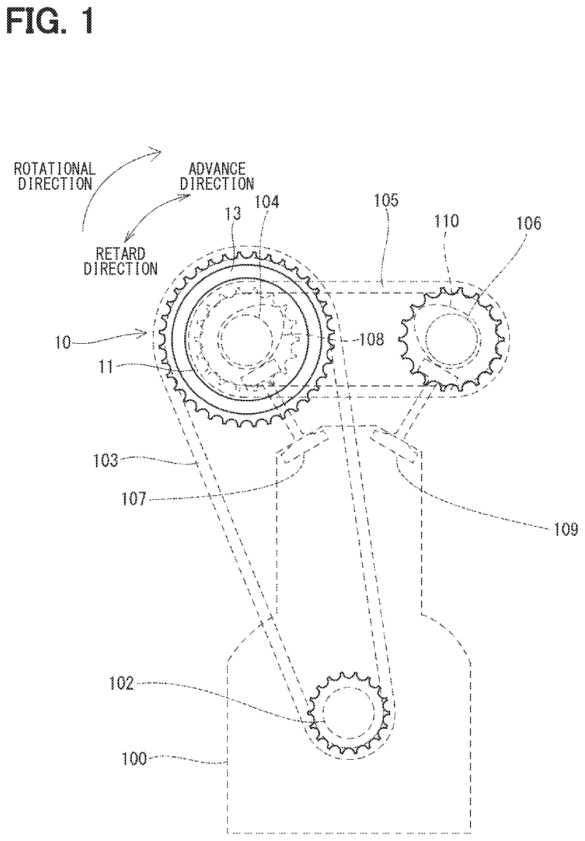

A first embodiment of the present disclosure will be described with reference to FIGS. 1 to 5. As shown in FIG. 1, according to a valve timing adjustment device 10 of the first embodiment, a crank shaft 102 of an internal combustion engine 100 for a vehicle rotates a first cam shaft 104 through a first chain 103, and the first cam shaft 104 rotates a second cam shaft 106 through a second chain 105. An intake cam 108 is arranged at the first cam shaft 104 and configured to adjust an opening/closing timing of a valve 107 which is an intake valve in accordance with rotation of the first cam shaft 104. An exhaust cam 110 is arranged at the second cam shaft 106 and configured to adjust an opening/closing timing of a valve 109 which is an exhaust valve in accordance with rotation of the second cam shaft 106.

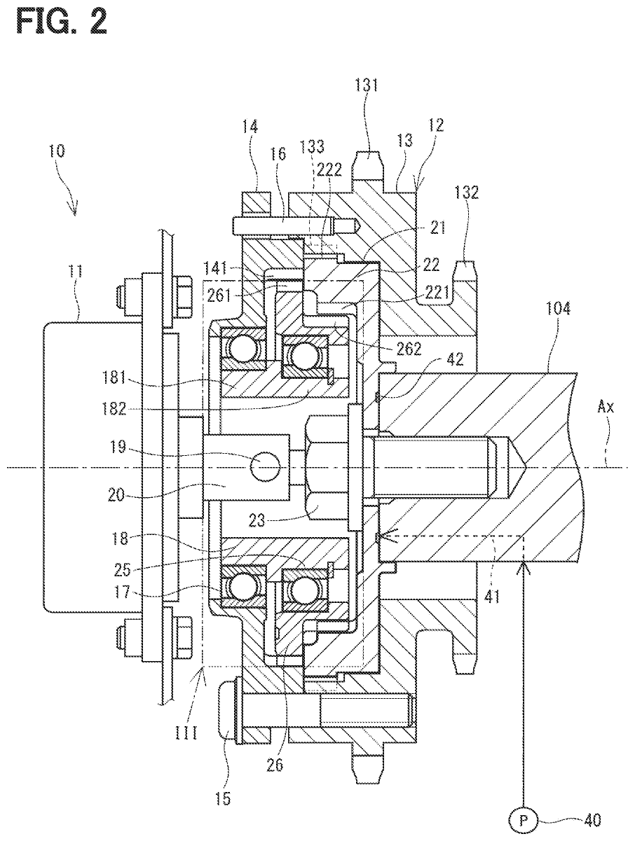

As shown in FIG. 2, the valve timing adjustment device 10 includes a speed reduction mechanism 12 driven by a motor 11. The speed reduction mechanism 12 includes a sprocket member 13 and a cover member 14 connected by a bolt 15 and a pin 16 so as to be rotatable integrally. A first sprocket tooth 131 and a second sprocket tooth 132 are provided at an outer periphery of the sprocket member 13. The first sprocket tooth 131 is configured to engage with the first chain 103. The second sprocket tooth 132 is configured to engage with the second chain 105.

An input member 18 is arranged inside the cover member 14 and supported rotatably through a first rolling bearing 17. The input member 18 formed in a cylindrical shape is connected to a motor shaft 20 by a joint 19 and configured to rotate about a central axis by the motor 11. The central axis is positioned at an axial line Ax of the input member 18 and the first cam shaft 104 (referred to as cam shaft 104 hereinafter). An output member 22 of the speed reduction mechanism 12 is rotatably arranged inside the sprocket member 13 through a slide bearing 21. The output member 22 formed in a cup shape is connected to the cam shaft 104 by a bolt 23 so as to be rotatable integrally.

The input member 18 includes a concentric portion 181 which is concentric with the cam shaft 104 and an eccentric portion 182 which is eccentric from the cam shaft 104. A planetary gear 26 is arranged at an outer periphery of the eccentric portion 182 and rotatably supported through a second rolling bearing 25. A large-diameter external tooth 261 and a small-diameter external tooth 262 are arranged at an outer periphery of the planetary gear 26. The large-diameter external tooth 261 engages with an internal tooth 141 of the cover member 14. The small-diameter external tooth 262 engages with an internal tooth 221 of the output member 22.

Multiple stoppers 222 are provided at the outer periphery of the output member 22 and protrude at positions separated each other through equal angles in a circumferential direction, Multiple contact portions 133 are provided at an inner periphery of the sprocket member 13 and can abut against the stopper 222. The output member 22 and the sprocket member 13 are combined so as to be rotatable integrally with each other in an angle range in which the stopper 222 is separated from the contact portion 133. An oiling passage 42 is formed at the output member 22, and the lubricating oil is supplied from a pump 40 to each beating 17, 21, 25 through an introduction passage 41 of the cam shaft 104 and the oiling passage 42.

Next, operation of the speed reduction mechanism 12 will be described. When the engine 100 is stopped, the output member 22 is stopped at a most retarded angle position, and the stopper 222 of the output member 22 is in contact with the contact portion 133 of the sprocket member 13. When operation of the engine 100 is started, the motor 11 rotates the input member 18 in a direction such that the contact between the stopper 222 and the contact portion 133 is maintained (retard direction in FIG. 1). Therefore, at immediately after starting the operation of the engine 100, the motor shaft 20, the input member 18, the output member 22, and the sprocket member 13 rotate at a same rotational speed.

When the cam shaft 104 of the valve timing adjustment device 10 rotates in an advance direction (referring to FIG. 1), the motor 11 drives such that a rotational speed of the input member 18 is higher than that of the sprocket member 13. Because of this, the planetary gear 26 rotates and revolves in the output member 22, and the output member 22 rotates in the advance direction relative to the sprocket member 13. As a result, a rotary phase of the cam shaft 104 advances, and the opening/closing timing of the valve 107, 109 is adjusted to an advance angle side.

When the cam shaft 104 of the valve timing adjustment device 10 rotates in the retard direction, the motor 11 drives such that a rotational speed of the input member 18 is lower than that of the sprocket member 13. Because of this, the planetary gear 26 rotates and revolves in the output member 22, and the output member 22 rotates in the retard direction relative to the sprocket member 13. As a result, the rotary phase of the cam shaft 104 is delayed, and the opening/closing timing of the valve 107, 109 is adjusted to a retard angle side.

When the cam shaft 104 reaches a target phase, the motor 11 is controlled so that the input member 18 and the sprocket member 13 rotate at the same rotational speed. Because of this, the planetary gear 26 does not rotate relative to the output member 22, and the output member 22 is kept at a predetermined phase (target phase) relative to the sprocket member 13. As a result, the rotary phase of the cam shaft 104 is kept at the target phase, and the opening/closing timing of the valve 107, 109 is kept at a predetermined timing. When a stop of the engine 100 is commanded, the output member 22 rotates in the retard direction relative to the sprocket member 13 and is stopped at the most retard angle position.

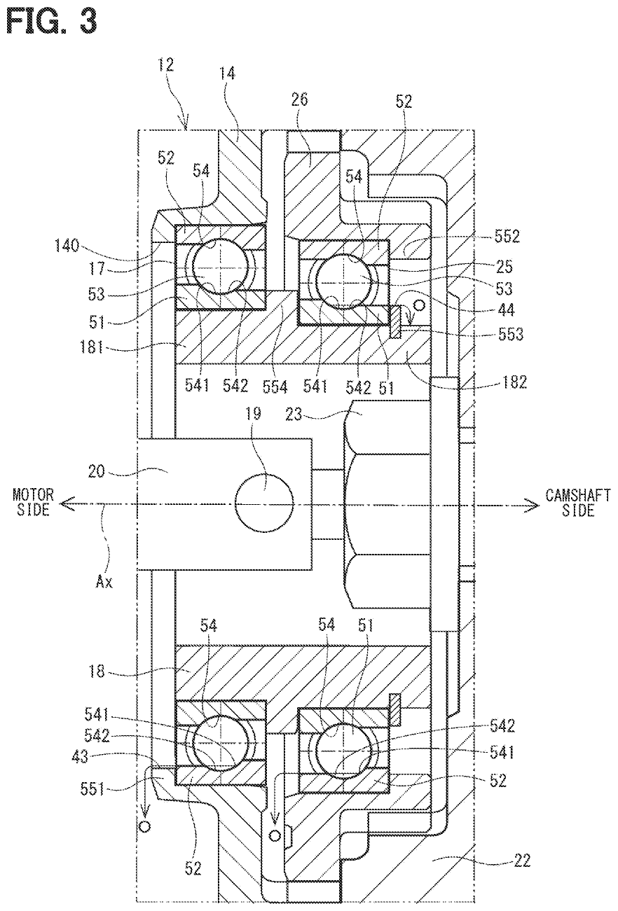

Configurations of the two rolling bearings 17, 25 will be described with reference to FIGS. 3 to 5. In the present embodiment, the first rolling bearing 17 is configured similarly to the second rolling bearing 25. Therefore, the configuration of the first rolling bearing 17 will be described below, and the same reference numerals as the first rolling bearing 17 are given to the second rolling bearing 25 in the drawing to eliminate redundant explanation.

As shown in FIG. 3, the first rolling bearing 17 (referred to as rolling bearing 17 hereinafter) includes an inner ring 51, an outer ring 52, and a rolling element 53 (sphere). Raceway grooves 54 are formed at surfaces of the inner ring 51 and the outer ring 52 that are opposed to each other and extend over entire circumferences. The raceway groove 54 is configured to guide the rolling element 53. The raceway groove 54 is asymmetric with respect to an axial direction of the rolling bearing 17 and includes a deep groove 541 and a shallow groove 542. The deep groove 541 is formed at one side with respect to a center of the rolling element 53 in the axial direction and has a relatively deep depth. The shallow groove 542 is formed at the other side with respect to the center of the rolling element 53 in the axial direction and has a relatively shallow depth shallower than the deep groove 541.

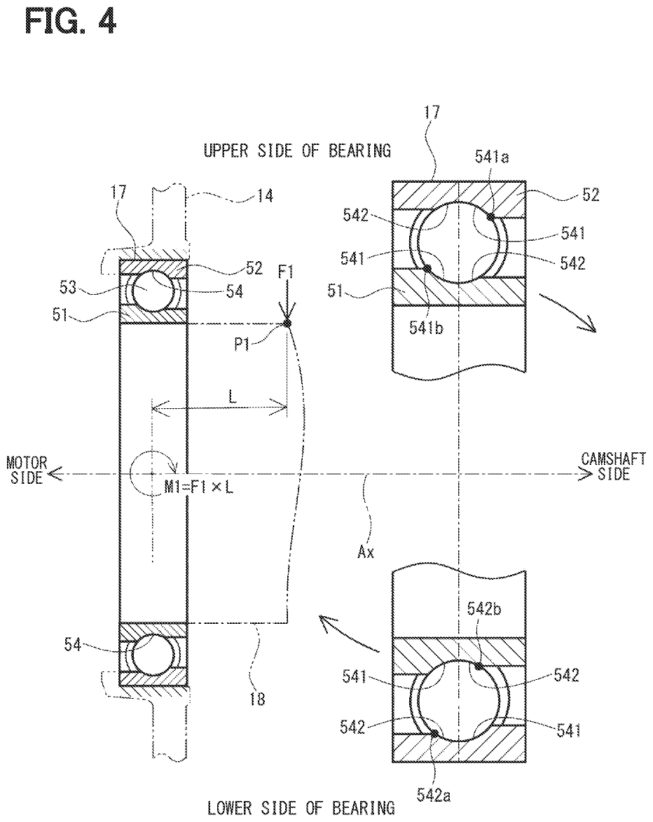

Specifically, as shown in FIG. 4, the deep groove 541 at the outer ring 52 is provided between an action point P1 of a moment load F1 applied to the inner ring 51 and the center of the rolling element 53 in the axial direction. The shallow groove 542 of the outer ring 52 is provided at an opposite side of the action point P1 with respect to the center of the rolling element 53. As shown in FIG. 4, L is a distance from the center of the rolling element 53 to the action point P1 of the moment load F1 in the axial direction. A moment M1 applied to the inner ring 51 is calculated as follow: M1=F1×L.

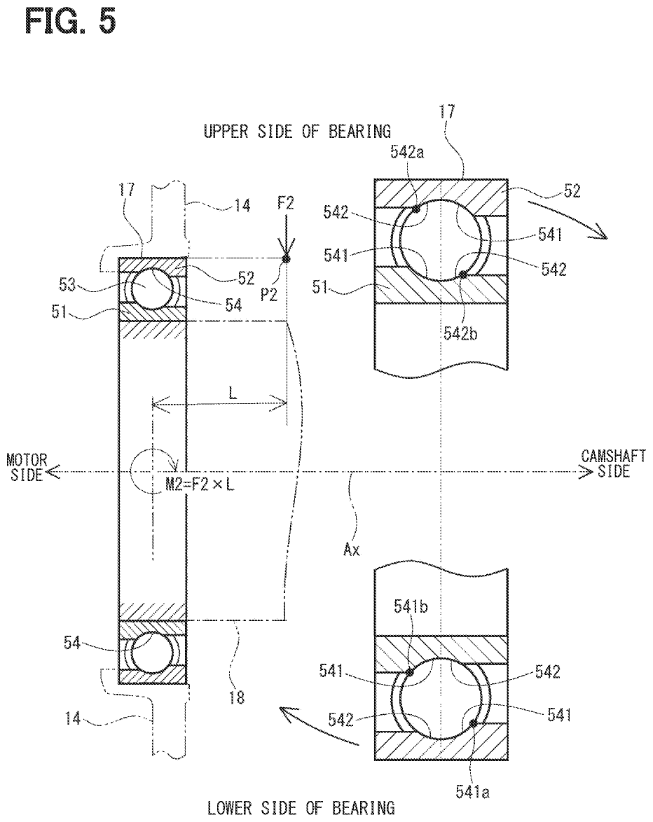

As shown in FIG. 5, the deep groove 541 of the inner ring 51 is provided at an opposite side of an action point P2 of a moment load F2 applied to the outer ring 52 with respect to the center of the rolling element 53. The shallow groove 542 of the inner ring 51 is provided between the action point P2 and the center of the rolling element 53 in the axial direction. As shown in FIG. 5, L is a distance from the center of the rolling element 53 to the action point P2 of the moment load F2 in the axial direction. A moment M2 applied to the outer ring 52 is calculated as follow: M2=F2×L.

As shown in FIG. 3, the two rolling bearings 17, 25 are fixed at a predetermined position in the axial direction by multiple thrust receivers 551, 552, 553, 554. A first thrust receiver 551 has an annular shape and surrounds a central hole 140 of the cover member 14. The first thrust receiver 551 holds and restricts the outer ring 52 of the rolling bearing 17 from moving toward the motor 11. A second thrust receiver 552 is formed integrally with the planetary gear 26 and connected to an inner peripheral surface of an end portion of the planetary gear 26 at a side adjacent to the cam shaft. The second thrust receiver 552 holds and restricts the outer ring 52 of the rolling bearing 25 from moving toward the cam shaft 104.

A third thrust receiver 553 has a ring shape and is engaged with the eccentric portion 182 of the input member 18, The third thrust receiver 553 holds and restricts the inner ring 51 of the rolling bearing 25 from moving toward the cam shaft 104. A fourth thrust receiver 554 is provided between the eccentric portion 182 and the concentric portion 181 and protrudes from the input member 18. The fourth thrust receiver 554 holds and restricts the inner ring 51 of the rolling bearing 17 from moving toward the cam shaft 104 and restricts the inner ring 51 of the rolling bearing 25 from moving toward the motor 11.

A first draining portion 43 is formed at the first thrust receiver 551 and has an annular shape. An inner diameter of the first draining portion 43 is larger than or equal to that of the outer ring 52. Lubricating oil 0 is discharged from the shallow groove 542 to an outside of the rolling bearing 17 through the first draining portion 43. A second draining portion 44 is formed at the third thrust receiver 553 and has an annular shape. An outer diameter of the second draining portion 44 is smaller than or equal to that of the inner ring 51 of the second rolling bearing 25. The lubricating oil 0 is discharged from the shallow groove 542 to an outside of the rolling bearing 25 through the second draining portion 44. The shapes of the first draining portion 43 and the second draining portion 44 are not limited to the annular shapes and may be serrated shapes, pulse wave shapes, or shapes like brims with holes, respectively.

In the valve timing adjustment device 10 of the first embodiment described above, a depth of the raceway groove 54 of the rolling bearing 17, 25 is different depending on a position in the axial direction. Therefore, when the engine 100 is stopped, the lubricating oil 0 flows down to the raceway groove 54 of the outer ring 52 by gravity. After that, the lubricating oil 0 flows from the shallow groove 542 to the outside of the rolling bearing 17, 25 through the first draining portion 43 of the thrust receiver 551. Therefore, an amount of the lubricating oil retained at the raceway groove 54 can be reduced, and resistance of the lubricating oil when or immediately after starting the engine can be reduced.

In the speed reduction mechanism 12, as the rolling bearings 17, 25 are provided around the input member 18 rotated at high speed by the motor 11, a response speed of the speed reduction mechanism 12 can be higher by reducing an amount of the lubricating oil retained. Further, in the present embodiment, while the two rolling bearings 17, 25 are lined in the axial direction, the resistance of lubricating oil is smaller than that in a conventional valve timing adjustment device, as the amount of the lubricating oil retained at each of the rolling bearings 17, 25 is small. Further, rigidity against the moment load F1, F2 is increased by the two rolling bearings 17, 25. Thus, the speed reduction mechanism 12 can be minimized and formed robustly.

When the moment load F1 acts on the inner ring 51, as shown in FIG. 4, a radial internal clearance is generated at an upper side of the rolling bearing, but is not generated at a lower side of the rolling bearing (similarly to the rolling bearing 25). At the upper side of the rolling bearing, a contact point between the rolling element 53 and the raceway groove 54 of the outer ring 52 is moved from the center of the rolling element 53 toward the action point P1. In addition, a contact point between the rolling element 53 and the raceway groove 54 of the inner ring 51 is moved from the center of the rolling element 53 away from the action point P1. However, as the deep groove 541 is provided at a position to which the contact point is moved, the contact point does not reach an end 541a, 541b of the deep groove 541. Therefore, wear and deformation of the end 541a, 541b are restricted. At the lower side of the rolling bearing, a contact point does not reach an end 542a, 542b of the shallow groove 542, as movement of the contact point is small. Therefore, the wear and the deformation of the end 542a, 542b are restricted.

When the moment load F2 is applied to the outer ring 52, as shown in FIG. 5, the radial internal clearance is not generated at the upper side of the rolling bearing, but is generated at the lower side of the rolling bearing. The contact point is moved from the center of the rolling element 53, however, does not reach the end 542a, 542b of the shallow groove 542 as the movement of the contact point is small. Because of this, the wear and the deformation of the end 542a, 542b are restricted. As a clearance is generated at the lower side of the rolling bearing, the contact point is moved greatly from the center of the rolling element 53. However, as the deep groove 541 is provided at a position to which the contact point is moved, the contact point does not reach the end 541a, 541b of the deep groove 541. Therefore, the wear and the deformation of the end 541a, 541b are restricted.

That is, if the inner ring 51 or the outer ring 52 is tilted by the moment load F1 F2, the wear and the deformation of the end of the raceway groove 54 are restricted, and durability of the rolling bearings 17, 25 can be improved. Therefore, reliability of the speed reduction mechanism 12 can be high in the valve timing adjustment device 10 in which the moment load F1, F2 repeatedly acts on the rolling bearing 17, 25 because of the eccentric rotation of the planetary gear 26.

### Second Embodiment

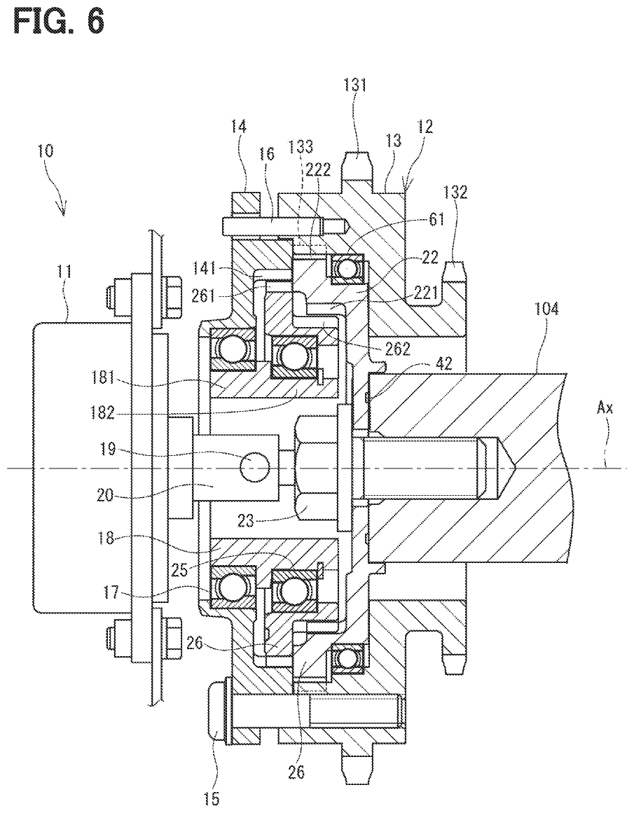

In the first embodiment, the two rolling bearings 17, 25 are provided at the speed reduction mechanism 12, however, the number of the rolling bearings is not limited. In a valve timing adjustment device of a second embodiment shown in FIG. 6, a third rolling bearing 61 is provided in addition to the first rolling bearing 17 and the second rolling bearing 25. The third rolling bearing 61 is provided at a low rotational speed side in the speed reduction mechanism 12 and arranged between the sprocket member 13 and the output member 22. Unlike the two rolling bearings 17, 25 provided at the high rotational speed side, the third rolling bearing 61 may be a radial ball bearing in which a depth of a raceway groove 54 is equal between both sides in the axial direction.

### Other Embodiments

The present disclosure is not limited to the above embodiments and can be appropriately modified in configuration of each part without departing from a spirit of the present disclosure.

(1) In the embodiments described above, the rolling bearing 17, 25 is provided at the input member 18 positioned at the high rotational speed side (referring to FIGS. 1 and 6). However, in another embodiment, the rolling bearing may be provided at the output member at the low rotational speed side, for example, when a speed reduction ratio is low.

(2) In the embodiments described above, the second draining portion 44 is provided at the third thrust receiver 553 (referring to FIG. 3). However, in another embodiment, the second draining portion may be omitted if the amount of the lubricating oil retained in the raceway groove 54 of the inner ring 51 at the lower side of the rolling bearing is small when the engine is stopped.

(3) In the embodiment described above, positions of the deep groove 541 and the shallow groove 542 are set in accordance with positions of the action point P1, P2 with respect to the center of the rolling element 53 (referring to FIGS. 4 and 5). However, in another embodiment, positions of the deep groove and the shallow groove are not limited, when the moment load is not required to be considered.

(4) When it is required to consider only the moment load F1 applied to the inner ring 51, the deep groove 541 of the outer ring 52 is provided between to the action point P1 and the center of the rolling element 53 (referring to FIG. 4). However, the deep groove 541 of the inner ring 51 is not limited in position.

(5) When it is required to consider only the moment load F2 applied to the outer ring 52, the deep groove 541 of the inner ring 51 is provided at the opposite side of the action point P2 with respect to the center of the rolling element 53 (referring to FIG. 5). However, the deep groove 541 of the outer ring 52 is not limited in position.

What is claimed is:

1. A valve timing adjustment device configured to adjust an opening/closing timing of a valve of an engine by rotation of a cam shaft driven by a motor, comprising:
a speed reduction mechanism that includes
a rolling bearing arranged between the motor and the cam shaft,
an oiling passage through which lubricating oil is supplied to the rolling bearing, and
a thrust receiver configured to lock the rolling bearing at a predetermined position in an axial direction, wherein
the rolling bearing includes a raceway groove to guide a rolling element at a surface of an inner ring and a surface of an outer ring opposed to each other,
the raceway groove includes a deep groove provided at one side with respect to a center of the rolling element in the axial direction, and a shallow groove that is shallower than the deep groove and provided at the other side with respect to the center of the rolling element in the axial direction, and
the thrust receiver includes a first draining portion to discharge the lubricating oil to outside of the rolling bearing from the shallow groove of the outer ring.

2. The valve timing adjustment device according to claim 1, wherein
the thrust receiver includes a second draining portion to discharge the lubricating oil to outside of the rolling bearing from the shallow groove of the inner ring.

3. The valve timing adjustment device according to claim 1, wherein
the deep groove of the outer ring is provided between the center of the rolling element and an action point of a moment load applied to the inner ring.

4. The valve timing adjustment device according to claim 1, wherein
the deep groove of the inner ring is provided at an opposite side of an action point of a moment load applied to the outer ring with respect to the center of the rolling element.

5. The valve timing adjustment device according to claim 1, wherein
the rolling bearing is arranged on an input member provided at a high speed side in the speed reduction mechanism.
